(19) United States
(12) Patent Application Publication
(10) Pub. No.: US 2024/0409030 A1
(43) Pub. Date: Dec. 12, 2024

(54) VEHICLE

(71) Applicant: AUTOX TECH PTE. LTD., Singapore (SG)

(72) Inventors: Zhenyu Li, Shenzhen (CN); Wen Xiao, Shenzhen (CN)

(73) Assignee: AUTOX TECH PTE. LTD., Singapore (SG)

(21) Appl. No.: 18/732,708

(22) Filed: Jun. 4, 2024

(30) Foreign Application Priority Data
Jun. 6, 2023 (CN) 2023214298523

(51) Int. Cl. B60R 1/12; B60Q 1/30; B60R 1/26; B62D 25/10; B62D 29/00; G03B 17/56

(52) U.S. Cl. CPC B60R 1/12; B60Q 1/30; B62D 25/105; B62D 29/001; B60R 2001/1223; B60R 2001/1253; B60R 1/26; G03B 17/561

(57) ABSTRACT

A vehicle provided includes a vehicle body, a plurality of sensors, and a plurality of vehicle components. The vehicle body includes an outer shell, and the plurality of sensors are integrated into the plurality of the vehicle components one by one, and the plurality of sensors and the plurality of vehicle components are enveloped by the outer shell.

This non-provisional patent application claims priority under 35 U.S.C. § 119 from Chinese Patent Application No. 202321429852.3 filed on Jun. 6, 2023, the entire content of which is incorporated herein by reference.

### TECHNICAL FIELD

The disclosure relates to vehicle technologies, particularly to a vehicle.

### BACKGROUND

The existing vehicles generally have a shell on vehicles' body that is composed of several separate parts that are assembled together, and Vehicle components, such as headlights and sensors and so on, are installed and exposed from the shell. Multiple installation slots need to be set on the shell to match the installation of the vehicle components, increasing the machining and manufacturing tolerance of the entire vehicle body. In addition, sensors, radars, and other sensors are generally threaded and exposed on the casing, not wrapped by the casing, and are prone to wear and tear, which can affect their service life.

### SUMMARY

In view of this, a vehicle is provided to reduces body tolerances and does not affect the service lives of sensors.

A vehicle includes a vehicle body, a plurality of sensors, and a plurality of vehicle components. The vehicle body includes an outer shell, and the plurality of sensors are integrated into the plurality of the vehicle components one by one, and the plurality of sensors and the plurality of vehicle components are enveloped by the outer shell.

Further, the vehicle body further comprises a frame, the outer shell comprises a metal shell and a plastic shell, the metal shell wraps around the frame, the metal shell provides with a plurality of open areas, the plastic shell is filled in a part of the open areas, the sensors and plurality of vehicle components are wrapped by the plastic shell.

Further, the vehicle components include vehicle lights, vehicle lights comprise two tail lights symmetrically arranged at a bottom of the frame, the two tail lights are located on a plane, and each tail light is integrated with one or more lights

Further, the plurality of sensors include a plurality of millimeter wave radars, the vehicle further comprises two front wheels, the metal shell is located on the left and right sides of the vehicle body with first open areas, the first open areas are located above each front wheel, and the tail end of each first open area facing the rear of the vehicle is flush with a longitudinal centerline of the wheel in a vertical direction, and a length is smaller than the radius of the wheel, the millimeter wave radars are mounted in the first open areas and wrapped in the plastic shell corresponding to the first open area.

Further, two sides of the first open area are inwardly retracted from a tail end to a front end, the plastic shell located in the first open area is in the shape of a bullet head, and a head of the bullet head is towards the front side of the vehicle body.

Further, the sensors further include a plurality of cameras, the metal shell comprises a back side and a tail side, and second open areas are located at positions adjacent to the back end and the rear end, each second open area is substantially rectangular in shape, and the two ends of each second open area along a lateral direction of the vehicle are substantially C-shaped, each second open area is filled with the plastic shell, and at least one camera and/or at least one millimeter wave radar are located at one end area of the second open area

Further, a front side of the metal shell extends downwards at the same angle from above the middle position of the frame towards both ends of the frame, and the front end of the metal shell extends to the front side of the front wheel, a part of the metal shell located above the front of the frame provides with a third open area for installing a front windshield.

Further, a Lidars, the Lidar are disposed on the top of the metal shell, the outer shell further includes a hood, and a curvature of the windshield is consistent with a curvature of the hood

Further, the vehicle components further include two electronic rearview mirrors, the electronic rearview mirror comprising a blind spot Lidar and/or a camera, the metal shell defines concaves corresponding to the electronic rearview mirrors, the metal shell further includes an mounting part, the mounting part is in a short cylindrical shape and located within the concave, and a central axis is along a vertical direction, and a fourth open area is provided on the outer side of the mounting part; each electronic rearview mirror further includes a plastic installation shell for wrapping around the blind spot Lidar and/or camera, the installation shell is installed into the mounting part, and the upper and lower ends of the mounting part are exposed to the installation shell, the blind spot Lidars and/or cameras are exposed to mounting part from the fourth open area.

Further, two sides of the first open area are inwardly retracted from a tail end to a front end, the plastic shell located in the first open area is in the shape of a bullet head, and a head of the bullet head is towards the front side of the vehicle body

Further, the plurality of the sensors further include a plurality of cameras, the metal shell comprises a back side and a tail side, and second open areas are located at positions adjacent to the back end and the rear end, each second open area is substantially rectangular in shape, and the two ends of each second open area along a lateral direction of the vehicle are substantially C-shaped, each second open area is filled with the plastic shell, and at least one camera and/or at least one millimeter wave radar are located at one end area of the second open area.

Further, a front side of the metal shell extends downwards at the same angle from above the middle position of the frame towards both ends of the frame, and the front end of the metal shell extends to the front side of the front wheel, a part of the metal shell located above the front of the frame provides with a third open area for installing a front windshield.

Further, the vehicle components further include two electronic rearview mirrors, the electronic rearview mirror comprising a blind spot Lidar and/or a camera, the metal shell defines concaves corresponding to the electronic rearview mirrors, the metal shell further includes an mounting part, the mounting part is in a short cylindrical shape and located within the concave, and a central axis is along a vertical direction, and a fourth open area is provided on the outer side of the mounting part; each electronic rearview mirror further includes a plastic installation shell for wrapping around the blind spot Lidar and/or camera, the installation shell is installed into the mounting part, and the upper and lower ends of the mounting part are exposed to the installation shell, the blind spot Lidars and/or cameras are exposed to mounting part from the fourth open area.

Further, a focal length of the camera is between 4 mm and 6 mm

The above vehicles mainly integrate sensors into vehicle components and are wrapped by the outer shell, thereby reducing the need for installation slots on the shell to cooperate with sensors and reducing the machining and manufacturing tolerances of the entire vehicle body. In addition, the vehicle components such as vehicle lights and sensors are wrapped inside the outer shell, which makes the vehicle components less susceptible to wear and tear and increases their service life.

To provide a clearer explanation of the structural features and functions of the present utility model, the following will provide a detailed explanation of the present utility model in conjunction with the accompanying drawings and specific embodiments.

### BRIEF DESCRIPTION OF THE DRAWINGS

FIG. 1 is a schematic diagram of the assembly structure of an embodiment of the present utility model.

FIG. 2 is a schematic diagram of one side structure of an embodiment of the present utility model.

FIG. 3 is another perspective structural diagram of an embodiment of the present utility model.

### DESCRIPTION OF COMPONENT LABELS IN THE DRAWINGS

10. Vehicle body; 11. Outer shell; 111. Metal shell; 1111. First open area; 1112. Second open area; 1113. Third open area; 1114. Fourth Open area; 112. Plastic shell; 113. Machine cover; 114. Windshield; 20. Tail lights; 30. Millimeter wave radar; 31. Lidar; 32. Blind spot Lidar; 40. Front wheel; 50. Camera; 60. Electronic rearview mirror; 61. mounting part; 62. Installation the shell; 70. Vehicle component.

### DETAILED DESCRIPTION OF THE EMBODIMENTS

In order to make the purpose, technical solution, and advantages of the present utility model clearer and clearer, the following is a further detailed explanation of the present utility model in conjunction with the accompanying drawings and implementation examples. It should be understood that the specific embodiments described here are only intended to explain the present utility model and are not intended to limit the present utility model.

It should be noted that when a component is referred to as “fixed to” another component, it can be directly attached to another component or there can be a centered component. When a component is considered to be “connected” to another component, it can be directly connected to another component or there may be a centering component present simultaneously. The terms “vertical”, “horizontal”, “left”, “right”, and similar expressions used in this article are for illustrative purposes only.

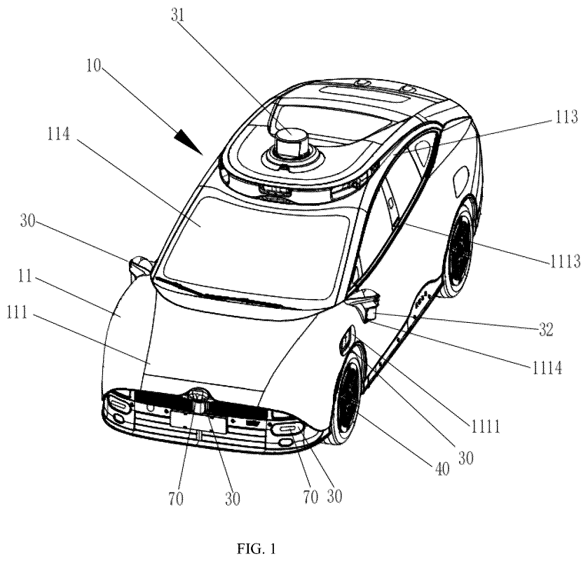

Referring to FIG. 1. a vehicle 100 provided in accordance with the embodiment, includes a vehicle body 10, a plurality of sensors 30, and a plurality of vehicle components 70. the vehicle body 10 includes an outer shell 11, the plurality of the plurality of sensors 30 are integrated into the plurality of the vehicle components 70 one by one, and the plurality of the sensors 30 and the plurality of the vehicle components 70 are enclosed with the outer shell 11. the vehicle body 10 further includes a frame 101. The outer shell 11 includes a metal shell 111 and a plastic shell 112. The metal shell 111 wraps around the frame 101, and the metal shell 111 is provided with a plurality of open areas 1110. The plastic shell 112 is filled in a part of the open areas 1110, and the plurality of sensors 30 and the plurality of vehicle components 70 are enclosed in the plastic shell 112.

The vehicle 10 differs from traditional vehicles by integrating vehicle components and sensors onto the outer shell 11, which reduces the need for installing mounting slots on the outer shell 11 that will fit with the vehicle components or sensors. As a result it decreases the manufacturing tolerances during the actual production of the outer shell 11 for the complete vehicle body 10.

In addition, the sensors and vehicle components are enclosed within the outer shell 11, which makes them less prone to wear and tear, thereby increasing their service life. Furthermore, if there are any malfunctions with the vehicle components or sensors, it is more convenient for users to repair or replace them as the components and sensors are grouped together, making it easier for users to identify the problem.

Referring to FIG. 3, as a preferred illustration, the plurality of the vehicle components 70 include a plurality of vehicle lights 70, and the plurality of sensors 30 include a plurality of millimeter wave radars 30. the vehicle lights 70 include two tail lights 20 symmetrically arranged at a bottom of the frame 101. The two tail lights 20 are located on the same plane, and each tail light 20 is integrated with one or more lamps. Integrating tail lights 20 and other lights 70 together, distinguishing traditional vehicles from separating tail lights 20 and other lights 70 and installing them separately on the outer shell 11, reduces the need for installation slots on the outer shell 11 for the tail lights 20 or other vehicle lights 70, and correspondingly reduces the manufacturing tolerance of the entire vehicle body 10 in the actual production of processing the outer shell 11.

Referring to FIG. 1, the plurality of sensors 30 include a plurality of millimeter wave radars 30, and the vehicle 100 includes two front wheels 40. The metal shell 111 corresponding to the left and right sides of the vehicle body 10 is equipped with first open areas 1111. Each first open area 1111 is located above each front wheel 40, and the tail end of each first open area 1111 facing a rear of the vehicle 100 is flush with the longitudinal centerline of the wheel 40 in a vertical direction and has a length smaller than a radius of the wheel 40. The plurality of millimeter wave radars 30 are set in the first open areas 1111 and are wrapped in the plastic shell 112 corresponding to the first open areas 1111. The millimeter-wave radar 30 is enclosed within the first open area 1111, which offers protection for the millimeter-wave radar 30.

Referring to FIG. 1, two ends of the first open area 1111 are retracted from an tail end to an front end, so that the plastic shell 112 located in the first open area 1111 is in a shape of a bullet head, and a head of the bullet head faces a front side of the vehicle body 10. The plastic shell 112, located in the first open area 1111, adopts principle of good airflow guidance, enhancing the stability of the vehicle during driving. Furthermore, by positioning the millimeter-wave radar 30 within the first open area 1111, it is not exposed to the exterior of the vehicle body 10, that will protect the millimeter-wave radar 30 and reduce chances of friction and collisions with other objects.

Referring to FIG. 3, the plurality of sensors 30 also include a plurality of cameras 50. The metal shell 111 includes a back side and a tail side, each position adjacent to the tail side and the back side and the tail side is designated as a second open area 1112. The second open area 1112 is roughly rectangular and elongated, and Two end areas of the second open area 1112 along a lateral direction of the vehicle 100 are substantially in a C-curve. The second open area 1112 is filled with a plastic shell 112, and at least one camera 50 and/or at least one millimeter wave radar 30 are located in one end of the second open area 1112.

The two ends of the second open area 1112 along the lateral direction of the vehicle 100 are substantially C-shaped and have a wrapping shape, which can wrap the millimeter wave radar 30 and camera 50 inside the second open area 1112, providing protection for the millimeter wave radar 30 and camera 50. The two end areas along the lateral direction of the vehicle 100 in the second open area 1112 form a substantially C-shape, and processing of the two end areas involves creating rounded edges, which is a relatively simple process in actual production.

The second open area 1112 with the two ends of C-shaped can improve the rigidity of the rear of the vehicle 100, as a result, it can reduce the impact force and protect the safety of users in the event of damage or accidents. The camera 50 and millimeter wave radar 30 can be integrated together to achieve better sensing sensitivity and imaging, and facilitate later maintenance and replacement, and correspondingly reduce the manufacturing process of the outer shell 11, that is, there is no need to manufacture more slots for millimeter wave radar 30 or camera 50 on the outer shell 11.

In addition, each camera 50 have a focal length of 6 mm or 4 mm, and users can choose different focal lengths of all camera 50 according to actual requirements. In this embodiment, each camera 50 adopts a focal length of 6 mm.

Referring to FIG. 1, the metal shell 111 extends downwards at the same angle from directly above a middle position of the frame 101 towards both ends of the frame 101, and a front end of the metal shell 111 extends to the front end of the front wheel. The metal shell 111 is located above the front of the frame and also has a third open area 1113 for installing the front windshield 114.

Referring to FIG. 1, the plurality of sensors 30 further includes a Lidar 31, which is located on a top of the metal shell 111. The outer shell 11 further includes a hood 113, and a curvature of the windshield 114 is consistent with that of the hood 113. Due to the curvature of windshield 114 is consistent with that of hood 113, as a result, it can achieve a sloping effect, improve the vehicle's wind direction, and increase the stability of vehicle driving.

Under the premise of meeting the requirements for autonomous driving, the impact sensation of the vehicle can be enhanced. When the vehicle moves forward against the wind, because the curvature of the windshield 114 is consistent with that of the hood 113, cause the airflow above to be faster than that below, so the vehicle body 10 will press down toward the ground to increase stability. In addition, the excitation radar 31 needs to rotate around the vehicle body 10 during operation, detect surrounding vehicles as well as road conditions and obstacles at a relatively long distance. The curvature e of the windshield 114 is designed to align with the curvature of the hood 113 to ensure that it does not obstruct the observation range of the Lidar 31.

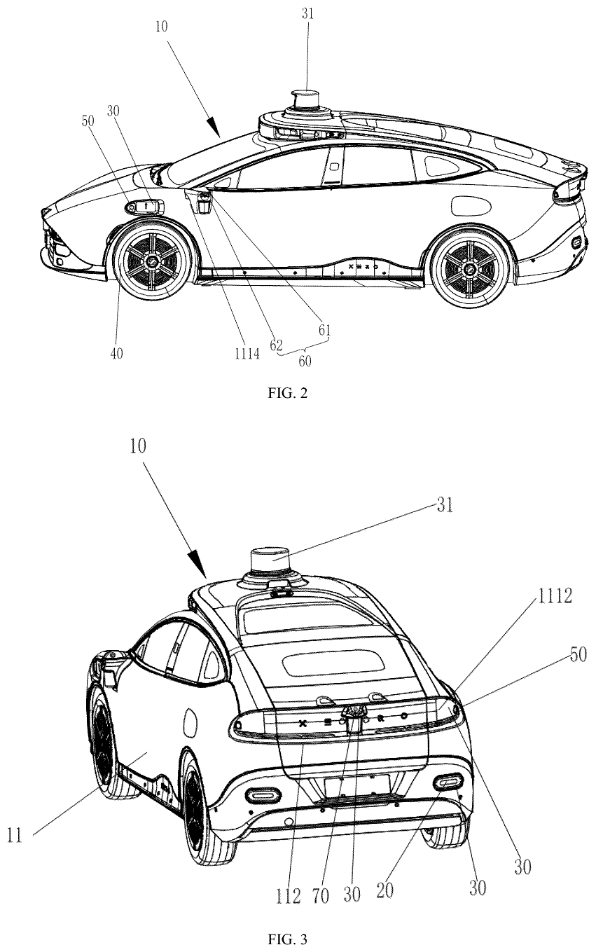

Referring to FIG. 2, the vehicle components 70 further include two electronic rearview mirrors 60. Each electronic rearview mirror 60 includes a blind spot Lidar 3231 and/or a camera 50. A position of the metal shell 111 corresponding to the electronic rearview mirror 60 is recessed to form a concave, and the metal outer shell 111 further includes a mounting part 61. The mounting part 61 is short cylindrical and located in the concave, and a central axis of the mounting part 61 is located in a vertical direction. An outer side of the mounting part 61 is equipped with a fourth open area 1114. The electronic rearview mirror 60 further includes a plastic mounting shell 62 for wrapping the blind spot Lidar 32 and/or camera 50. The mounting shell 62 is installed into the mounting part 61, and the upper and lower ends are exposed to the mounting part 61. The blind spot Lidar 32 and/or camera 50 are exposed to the mounting part 61 from the fourth open area 1114.

Each electronic rearview mirror 60 is equipped with a mounting part 61 and the installation shell 62, which can wrap the blind spot Lidar 32 and/or camera 50 within the electronic rearview mirror 60, that serves a protective role for the radar, and also facilitates easy disassembly, installation, and maintenance for users.

The blind-spot Lidar 3231 is primarily used for blind-spot compensation, real-time detection and sensing of the road conditions around the vehicle, and prompt feedback of information to the user. Each electronic rearview mirror 60 is composed of the blind-spot Lidar 32 and the camera 50, which improves the monitoring performance of blind spots and provides a wider monitoring angle compared to traditional rearview mirrors. In this embodiment, the camera 50 adopts a fisheye camera 50, whose lens achieves the maximum camera viewing angle, belonging to a super-wide-angle lens. Its viewing angle reaches or exceeds the range visible to human eyes, thus providing a wider monitoring range, which is more conducive to safe travel for users.

In this embodiment, the sensors use millimeter wave radars and Lidars, which have a simple RF hardware structure, low transmission power, and small antenna aperture, ensuring excellent angular resolution.

The above are only preferred embodiments of this utility model and are not intended to limit it. Any modifications, equivalent replacements, and improvements made within the principles of this utility model should be included within the scope of protection of this utility model.

1. A vehicle, comprises
a vehicle body, comprising an outer shell;
a plurality of vehicle component; and
a plurality of sensors, integrated into the plurality of the vehicle components one-by-one, and the plurality of sensors and plurality of vehicle components are enveloped by the outer shell.

2. The vehicle of claim 1, wherein the vehicle body further comprises a frame, the outer shell comprises a metal shell and a plastic shell, the metal shell wraps around the frame, the metal shell provides with a plurality of open areas, the plastic shell is filled in a part of the open areas, the sensors and plurality of vehicle components are wrapped by the plastic shell.

3. The vehicle of claim 1, wherein the vehicle components include vehicle lights, vehicle lights comprise two tail lights symmetrically arranged at a bottom of the frame, the two tail lights are located on a plane, and each tail light is integrated with one or more lights.

4. The vehicle of claim 2, wherein the plurality of sensors include a plurality of millimeter wave radars, the vehicle further comprises two front wheels, the metal shell is located on the left and right sides of the vehicle body with first open areas, the first open areas are located above each front wheel, and the tail end of each first open area facing the rear of the vehicle is flush with a longitudinal centerline of the wheel in a vertical direction, and a length is smaller than the radius of the wheel, the millimeter wave radars are mounted in the first open areas and wrapped in the plastic shell corresponding to the first open area.

5. The vehicle of claim 4, wherein two sides of the first open area are inwardly retracted from a tail end to a front end, the plastic shell located in the first open area is in the shape of a bullet head, and a head of the bullet head is towards the front side of the vehicle body.

6. The vehicle of claim 4, wherein the plurality of the sensors further include a plurality of cameras, the metal shell comprises a back side and a tail side, and second open areas are located at positions adjacent to the back end and the rear end, each second open area is substantially rectangular in shape, and the two ends of each second open area along a lateral direction of the vehicle are substantially C-shaped, each second open area is filled with the plastic shell, and at least one camera and/or at least one millimeter wave radar are located at one end area of the second open area.

7. The vehicle of claim 4, wherein a front side of the metal shell extends downwards at the same angle from above the middle position of the frame towards both ends of the frame, and the front end of the metal shell extends to the front side of the front wheel, a part of the metal shell located above the front of the frame provides with a third open area for installing a front windshield.

8. The vehicle of claim 7, wherein the sensors further comprise Lidars, the Lidars are disposed on the top of the metal shell, the outer shell further includes a hood, and a curvature of the windshield is consistent with a curvature of the hood.

9. The vehicle of claim 1, wherein the vehicle components further include two electronic rearview mirrors, each electronic rearview mirror comprising a blind spot Lidar and/or a camera, the metal shell defines concaves corresponding to the electronic rearview mirrors, the metal shell further includes an mounting part, the mounting part is in a short cylindrical shape and located within the concave, and a central axis is along a vertical direction, and a fourth open area is provided on the outer side of the mounting part; each electronic rearview mirror further includes a plastic installation shell for wrapping around the blind spot Lidar and/or camera, the installation shell is installed into the mounting part, and the upper and lower ends of the mounting part are exposed to the installation shell, the blind spot Lidars and/or cameras are exposed to mounting part from the fourth open area.

10. The vehicle of claim 6, wherein a focal length of the camera is between 4 mm and 6 mm.

11. The vehicle of claim 9, wherein a focal length of the camera is between 4 mm and 6 mm.
